(19) United States
(12) Patent Application Publication
(10) Pub. No.: US 2006/0002540 A1
(43) Pub. Date: Jan. 5, 2006

(54) Real-time customer service representative workload management

(76) Inventors: Barrett Kreiner, Norcross, GA (US); Ronald Perrella, Norcross, GA (US)

Correspondence Address: WITHERS & KEYS FOR BELL SOUTH, P. O. BOX 71355, MARIETTA, GA, 30007-1355, US

(21) Appl. No.: 10/884,504

(22) Filed: Jul. 2, 2004

(51) Int. Cl. H04M 3/00; H04M 5/00

(52) U.S. Cl. 379/265.02; 379/265.06

(57) ABSTRACT

A system and method is provided that includes an automatic call distribution system adapted to communicate over a network and includes a software control module. The automatic call distribution system is configured to route incoming calls received from the network to a call agent station in communication therewith based on metrics information identified by the software control module. The metrics information is correlated between the client and the call agent. The system provides an interactive voice response system in communication with the automatic call distribution system for administering a survey to a client in communication with the call agent station. Under the control of the software control module, the automatic call distribution system routes the incoming call from the call agent station to the interactive voice response system for administering the survey to the client.

### BACKGROUND

The present invention relates generally and in various embodiments to systems and methods for improving business process performance and profitability by optimizing resource loading through workload management. More specifically, the present invention relates generally and in various embodiments to systems and methods for improving business process performance and profitability of an organization's call center by tracking, analyzing, and identifying call agents (e.g., customer service representatives, third party organizations, employees of the organization, contract employees, or consultants) having the appropriate skills to serve the needs of particular clients of the organization. In accordance with embodiments of the present invention, a call agent's skills are adaptively and continuously matched to the needs of the clients based on statistical data gathered through a variety of feedback processes.

Although various implementations of the present invention, among many, may be described herein with reference to the specific illustrative embodiments related to particular applications, those skilled in the art will understand that the invention is not intended to be limited to such embodiments and/or applications in any way. Those having ordinary skill in the art and reference to the description of the embodiments described herein will recognize additional modifications, applications, and other embodiments falling within the scope of the claimed invention and additional fields in which the present invention may be practiced.

As used herein, the term “call agent” comprises, for example, a customer service representative or other resource of an organization suited to provide assistance to various clients over a communication network. As used herein, the term “client” comprises, for example, callers, customers, shoppers, consumers, patrons, users, buyers, purchasers, and/or end-users of any number of services and/or commodities provided by the organization.

To maintain an edge in today's competitive business environment it is essential for organizations to streamline and adapt their current business practices so as to maximize customer service. One way to do this is by routing customer service calls to various resources based on the individual skills of a particular resource in handling a specific client's issues. Therefore, there is a need for organizations to establish the skill sets and skill levels of their resources such as, for example, call agents, based on feedback data obtained through various methods and using that data in an overall business process management work flow system to maximize customer service for the client.

Organizations may obtain such feedback data on a real-time basis and develop a dynamic adaptive profile of the client's needs versus services rendered by a particular call agent. The data may be stored and continuously updated in a historical database. The historical data then may be used by the organization to ascertain the various skill sets and skill levels of their internal resources (e.g., call agents) and develop their skills and match them to specific client needs. This is especially true in many service industries, where a client's perception of the quality of the services rendered by the service provider (e.g., the organization via its call agents) may be the only distinction between competing service providers.

Many methods have been devised to improve customer service satisfaction. Current methods, however, have not always yielded satisfactory results, due in part to the inherent time delay in analyzing, applying, and adapting the client feedback data such that the best overall resource is selected to address a particular client's needs. The time delay makes it difficult to identify the appropriate resource that should address any immediate client concerns during a service call transaction. For example, most organizations have customer service call centers that utilize automatic call routing systems for allocating call agents to address incoming calls from a particular client.

Present methods and systems, however, do not correlate clients and agents, but rather they distribute incoming calls from clients based on a number of ranking factors such as, for example, best call agent first, call queuing in first availability, round robin distribution, longest idle call agent, call agent with fewest calls, call agents with least talk time, all call agents simultaneously, overflow call agent tiers at high call volume times, or the relative value of a call agent. These ranking factors do not utilize qualitative data in deciding which call agent should handle a particular client's call. Rather, the call agent is allocated either randomly or based on the ranking factors. These ranking factors, however, disregard any correlation between a call agent's skills and a particular client's needs. For example, a call agent may have a particular affinity or may have acquired certain skill sets for handling a particular client or client's needs. Without the proper metrics, however, the affinity or developed skill set of a call agent for handling a particular client cannot be incorporated in the ranking factors as part of the call routing decision making process.

### SUMMARY

In one general respect, an embodiment of the present invention is directed to a system. The system includes an automatic call distribution system adapted to communicate over a network, wherein the automatic call distribution system comprises a software control module, and wherein the automatic call distribution system is configured to route incoming calls received from the network based on metrics information identified by the software control module; and a call agent station in communication with the automatic call distribution system, wherein the call agent station is configured to receive incoming calls routed from the automatic call distribution system based on the metrics information determined by the software module.

In another general respect, an embodiment of the present invention is directed to as system. The system includes an automatic call distribution system adapted to communicate over a first network and a second network, wherein the automatic call distribution system comprises a software control module, and wherein the automatic call distribution system is configured to route incoming messages received from the first network and is configured to route incoming calls received from the second network, wherein the messages and the calls are routed based on metrics information identified by the software control module; a server in communication with the automatic call distribution system, wherein the server is adapted for receiving the incoming messages from the first network; and a call agent station in communication with the automatic call distribution system, wherein the call agent station is configured to receive the incoming messages and incoming calls routed from the automatic call distribution system based on the metrics information determined by the software control module.

In yet another general respect, an embodiment of the present invention is directed to a method. The method includes initiating an incoming call with a call center by a client; and at the call center, routing the incoming call to a call agent based on metrics information correlated between the client and the call agent.

Other systems, methods, and/or computer program products according to embodiments of the present invention will be or become apparent to one with skill in the art upon examination of the following drawings and detailed description. It is intended that all such additional systems, methods, and/or computer program products be included within this description, be within the scope of the present invention, and be protected by the accompanying claims.

### DESCRIPTION OF THE DRAWINGS

Embodiments of the present invention are described herein in conjunction with the following figures, wherein:

FIG. 1 illustrates various embodiments of a system for conducting real-time workload management according to the present invention; and

FIG. 2 is a process flow diagram of a real-time workload management process of various embodiments of the present invention.

### DESCRIPTION

It is to be understood that the figures and descriptions of the various embodiments of the present invention described herein, among others, have been simplified to illustrate representative elements of a system and method for improving and optimizing business processes and resource loading that are relevant for a clear understanding of the present invention, while eliminating, for purposes of clarity, other elements. For example, embodiments of the present invention relate generally to systems and methods for matching an organization's resources skill sets to the needs of clients of the organization by adaptively matching the resources and clients based on historical data gathered through a feedback process. Examples of obtaining client feedback may be found in commonly assigned co-pending application Ser. No. 10/702,329 “REAL-TIME CLIENT SURVEY SYSTEMS AND METHODS” and Ser. No. 10/746,804 “CLIENT SURVEY SYSTEMS AND METHODS USING CALLER IDENTIFICATION INFORMATION,” which are incorporated herein by reference in their entirety.

As discussed previously, the term “client” as used herein comprises, for example, a customer, shopper, consumer, patron, user, buyer, purchaser, and/or end-user of any number of services and/or commodities. Services can include both commercial and non-profit services, for example. An “organization” as used herein comprises, for example, any individual, establishment, institution, business, firm, company, concern, and/or non-profit organization, combinations thereof, and the like. The term “call agent” comprises, for example, a customer service representative or other resource of an organization suited to provide assistance to various clients over a communication network.

It is to be understood that call centers, automatic call distributor (ACD) systems, interactive voice response (IVR) systems, and business process management software (BPM) platforms illustrated herein are provided merely as examples of systems that provide an operating environment for and are used in conjunction with various embodiments of the present invention. To facilitate a better understanding of the present invention, the illustrated operating environments are described herein merely as examples of systems that cooperate to improve business process performance and profitability by optimizing resource loading through workload management. Those of ordinary skill in the art will appreciate and readily understand, however, that other elements may be used in conjunction therewith to provide additional operating environments for embodiments of the present invention.

At some point the organization may be interested in improving its business process performance and profitability by optimizing certain areas of their operations such as, for example, resource loading of their call agents and managing their workload based on feedback from existing or prospective clients to appraise or measure the client's perception of the organization. This includes, for example, appraising and/or measuring the quality of the services and commodities provided by the organization and which specific call agent from a pool of call agents may best process a client's call.

Various embodiments of the present invention provide systems and methods for managing resource workloads in real-time. The systems and methods for conducting real-time workload management in accordance with embodiments of the present invention use a BPM software platform. The systems and methods are interactive, operate in real-time or near real-time, and are client friendly. The BPM software platform uses call agent feedback data and other factors collected as part of an overall business process management workflow system to route client calls based on individual call agent's compatibility with the client. Thus, a knowledge based system can be implemented that correlates a specific call agent and a client based on historic information. For example, the BPM software platform includes executable modules to route incoming calls to individual call agents, and collects and stores various metrics data in real-time. The metrics data includes, for example, the time it takes a call agent to complete a call, the quality of the agent's work, and the number of manager escalations required to resolve issues, among others. The metrics data are stored in local or remote databases and are correlated to the specific call agent and client involved in the measured transaction. Further, based on the metrics data and the identity of the client placing the call, the BPM executable module determines which call agent to route an incoming call and an optimal number of calls to route to the call agent. The BPM executable module then manages the amount of work to be given to the call agent so as to maximize the agent's work load while maintaining the quality of the work product or delivered service at or above an acceptable predetermined level. As the call agent's work product quality and quantity deviates from the predetermined level and amount, respectively, the BPM software automatically alters the call agent's workload in accordance with the deviation. The BPM software, therefore, may be used to improve the organization's responsiveness to its clients while at the same time matches the call agents' workloads in accordance with their capabilities that are most compatible with the client's needs.

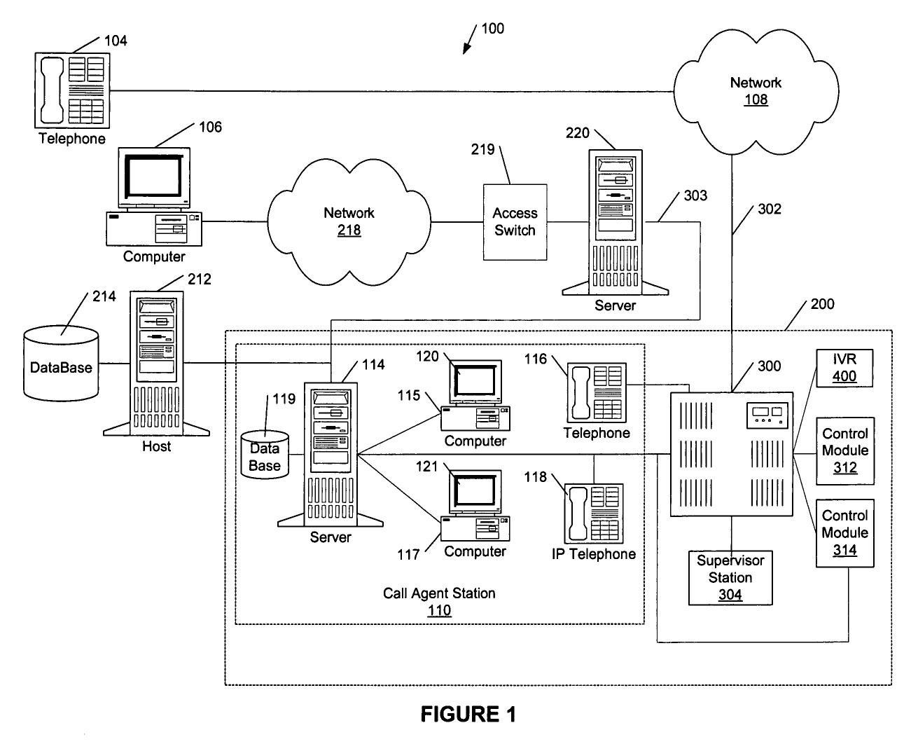

FIG. 1 illustrates one of various embodiments of a system 100 according to the present invention. The system 100 comprises, for example, a call center 200 (e.g., a customer service center), a first communications network 108 primarily for handling voice information, and a second communications network 218 primarily for handling data.

The call center 200 is a specialized environment that is equipped, staffed, and managed by an organization to handle incoming calls. In general, the call center 200 is used by organizations that handle a large volume of calls. The call center 200 includes a routing platform or Automatic Call Distribution (ACD) system 300 in communication with the first network 108 and an Interactive Voice Response (IVR) system 400. The ACD system 300 also may include other systems such as a fax server, voice mail, and the like. The call center 200 may be located at one specific site or may comprise a number of call centers that are remotely distributed and interconnected via one or more communications networks.

The call center 200 also includes a call agent station 110 or a call agent position, for example. The number of call agent stations 110 varies proportionately with the number of call agents working at the call center 200. The agent station 200 may number from a few to several thousand depending on the number of call agents working at a particular call center 200 and the number of calls handled by the call center 200. The call agent station 110 also may include a server 114 in communication with a database 119, one or more telephones 116, and one or more Internet Protocol (IP) telephones 118, for example. The server 114 includes network connectivity and is connected to one or more computers 115, 117 (e.g., desktop or portable personal computers, workstations, and the like). The computers 115, 117 generally include, for example, a display screen 120, 121, respectively, for the call agents to view information. The call center 200 telephones 116 include multi-button functionality and can be equipped with a headset to free up the call agent's hands for entering the client's information into the call agent's computer 115, 117 via a keyboard associated with the computer 115, 117. The call agent station 110 also may include an IP telephone 118 that integrates both voice and data, for example.

The call center 200 connects to the outside world via both voice communication lines 302 and data lines 303, for example. The call center 200 may subscribe to various communication services comprising a digital line service such as 56K, Fractional T1 or T1, and ISDN, for example. Other communication services comprise, for example, 800 toll-free numbers to take orders or 900 numbers to provide a service that can be charged to the client's telephone bill.

The ACD system 300 also may include one or more software control modules 312 for re-routing incoming calls to the IVR system 400 at the end of a transaction to administer a client satisfaction survey, for example. The software control module 312 is executed either by the ACD system 300 directly or a host computer 212 in communication with the call center 200 and/or the server 114. The host computer 212 is in communication with a database 214. The ACD system 300 also executes one or more software control modules 314 for controlling various aspects of data management associated with the operation of the call center 200. In one of many embodiments of the present invention, the software control module 314 is a BPM software platform that manages the call center's 200 activities and continuously analyzes data. The software control module 314 uses the data to determine call agent trends correlated to a specific client and adapts the call agent's workload in real-time based on the data, for example. The ACD system 300 can be a stand alone switching system or may be integrated with a PBX system at the call center 200. The functionality of the ACD system 300 may be provided by a telephone company's central office or as part of the carrier's Centrex services, for example. Those skilled in the art will appreciate that the software control modules 312, 314 can be contained in a single executable software control module or may be distributed as two or more separate software control modules without departing from the scope of the invention.

The ACD system 300 is a general-purpose system that may be used by an organization to implement the various embodiments of the present invention. The ACD system 300 may be installed at the call center 200 for handling a large number of incoming calls and employs a plurality of call agents whose responsibilities are almost entirely restricted to handling the incoming calls. The ADC system 300 may be used to rapidly route incoming calls to available call agents that either are available or are qualified (e.g., have the appropriate technical expertise) to address the client's needs. The ACD system 300 can be used in any one of the following call center 200 environments or applications, among others: customer service centers; help desk; order entry; credit authorization; reservations; insurance claims; and catalog sales, for example. The ACD system 300 can incorporate the latest call-processing technology and benefit from the improvements made in the public switched telephone network, developments in Computer Telephony Integration (CTI), the Internet, and advancements in personal computer related technologies, such as, for example, multimedia technology.

The ACD system 300 may be used to greet clients with recorded messages, provide a menu of dial options, and to route incoming calls to the appropriate call agents. The ACD system 300 also may be used to re-route a call to the IVR system 400 to conduct a feedback survey shortly after a call agent/client transaction is over. The information garnered from the client by way of the survey is generally more meaningful if the survey is conducted shortly after the interaction between the client and the call agent. The ACD system 300 also may be linked via private lines to handle calls from within the organization and to form a distributed call-processing system for routing incoming calls over the communication networks 108, 218 to various different geographic locations of the organization and then re-routing the client to the IVR system 400 to conduct the client feedback survey. The ACD system 300 also may handle incoming calls from the network 218 (e.g., the Internet).

In various embodiments of the present invention, the ACD system 300 comprises various business process execution engines such as software control module 312 for re-routing the client to the IVR system 400 and BPM control module 314 for real-time workload management. The BPM control module 314 also performs call management and statistical reporting functions such as, for example, tracking the number of incoming calls handled, tracking the number of clients who elected to participate in the survey, tracking the number of clients that were successfully re-routed to the IVR system 400, tracking the number of clients that initially agreed to conduct the survey but later chose to abandon the process, and other tracking functions, for example.

The ACD system 300 routes the incoming calls to a specific call agent that is correlated to the client based on historical information garnered from previous transactions between the call agent and the client, for example. The historical information may be stored in either database 119 or 214, for example. As described previously, the call agent may be, for example, an order taker, a customer-service representative, a help-desk operator, or some other type of customer service representative or agent. If the appropriate call agent cannot answer some of the incoming calls immediately, the calls are placed in a queue and the client waits for the next available call agent that is identified by the BPM control module 314 as being appropriate for handling the client's needs. If there are no correlated call agents available, the incoming call defaults to the next available call agent based on traditional call distribution methods. The call center 200 also may provide a menu of dialing choices for the client so they may choose to be routed to a call agent of their choice.

The call agents may be connected to the clients over the telephone network 108, for example, through telephone 116 via voice communication line 302. Data to support call center services and activities can be maintained on a separate parallel data network 303, for example. A client may communicate with the call center 200 using a variety of communication devices such as, for example, a telephone 116 (e.g., land line or wireless) and can include a touch-tone keypad or a computer 106. The client may communicate with the call center 200 through the first network 108 and the incoming call then may be routed by the ACD system 300 to a call agent station 110 where a call agent is ready to assist the client.

Embodiments of the present invention will be described herein with respect to managing the call agents' workloads in real-time within the call center 200 environment using the BPM control module 314. Those of ordinary skill in the art will appreciate, however, that other operating environments may be readily substituted without departing from the scope of the invention. In various embodiments of the present invention, a call agent handles a client's call to the call center 200. At the end of the call, the call agent transfers the client to the IVR system 400, for example, for the administration of a feedback survey or questionnaire. The survey may be automatically administered through the IVR system 400 to gather client feedback information soon after the call agent/client transaction is completed.

Those skilled in the art will appreciate, however, that although the process in accordance with various embodiments of the present invention will be described herein with respect to using the telephone 104 and the personal computer 106 as the communication interface between the client and the call agent, and/or the organization, other communication interfaces, environments, or apparatuses may be employed by the client and/or the organization to implement the process. Those skilled in the art will appreciate that embodiments of the present invention may be employed in a variety of communications environments without departing from the scope of the invention.

Furthermore, the various embodiments of the present invention may be interconnected via many different types and variations of communication networks 108, 218. These networks may include computer networks or telecommunications network, and are not intended to be limited to the networks 108, 218 described herein. Rather, the many embodiments of the present invention may be practiced in a variety of communication network operating environments including, for example, computer networks and telecommunications systems comprising packet-switches, servers, and modules capable of transmitting and receiving information in the form of packets between various devices interconnected over any predetermined computer and telecommunications networks. The many embodiments of the present invention can operate in various communications environments comprising packet-switched networks, Voice over Internet Protocol (VoIP), wireless Fidelity (WiFi), Bluetooth, Ultrawideband, and other operating communications environments, for example.

The communication networks 108, 218 also may include, for example, WAN, LAN, Ethernet, Internet, Web-based networks, and telecommunication networks, among others. In various environments communication between the client and the organization via the call agent may be achieved over computer networks that are interconnected via telephone lines such as a variety of digital transmission links including those provided by the local telephone company such as, for example, a digital subscriber line (DSL), an asymmetrical digital subscriber line (ADSL), a high bit rate digital subscriber line (HDSL), a single pair symmetrical services (SDSL), an integrated services digital network (ISDN) line, a T-1 digital transmission link, and/or a wireless communication line, for example.

When a call agent is assigned to the client, the call agent initially addresses the client's immediate requirements or concerns. At that time, the call agent also may obtain relevant information from the client such as the client's identification information and may enter or store this information in either database 119 or 214 along with the call agent's identification information so that any data stored during the transaction may be correlated between the client and the call agent. The information stored in either database 119 or 214 also is associated or correlated with the results of the client feedback survey. Thus, the client's and the call agent's identification information and the feedback data may be correlated to each other so that a historical database of correlated data is created and may be updated on an ongoing basis.

In one embodiment of the present invention, the call agent interacts with the client at the call center 200 via the call agent's computer 115, 117 and telephones 116, 118. The call agent enters the client's personal information by filling out standard forms that appear on the display screen 120, 121 of the computer 115, 117, for example. The call agent's computers 115, 117 are in communication with the server 114 and the database 214, for example. The database 214 can be used to store the client's personal information in a central location. The database 214 also can be used to store BPM metrics data. The host computer 212 also can be used to store the client records in a variety of ways and can be used to generate client reports and to store BPM metrics data, for example. Additional components of the call center 200 also may include various management information tools to allow managers to query either database 119 or 214 and retrieve the stored information. The managers may use the tools to correlate or associate the stored information with the client survey information, along with the client and call agent identification information, for example. The information stored in either database 119 or 214 also may include the telephone number of the call agent's station 110 so that incoming calls can be traced to the particular call agent station 110 at the time client services were rendered, for example. If the client later chooses to participate in the feedback survey, the results may be correlated or associated with the stored client information as well as the telephone number of the call agent's station 110 or the call agent's identification number.

In various embodiments of the present invention, the call center 200 may be integrated with the second network 218 through an access switch 219 and a server 220. The second network 218 may be the Internet and the server 220 may be a web server, for example. Integrating the Internet with the call center 200 provides the organization with additional personalized services to better serve the client by providing various web sites and options to access the call agents online. The client thus may initiate a transaction using a computer 106 and communicate with the call center 200 online via a web site. At any time the client may ask questions by selecting a preferred method of online communication by submitting a question in an online form and having the call agent respond online via e-mail, telephone, or fax, for example. In various embodiments of the present invention, the client also may conduct transactions with the call center 200 through a call center web site hosted by the server 220 via interactive text-chat sessions with the call agent online or place a telephone call over the Internet to talk to the call agent. During a real-time transaction with the client over the call center web site, the call agent may push web pages containing appropriate text and images to the client's computer 106. The web pages may contain, for example, information that help answer complex questions or illustrative examples.

At the end of a transaction with the call agent online, the client again may elect to participate in a client feedback survey to ascertain whether the call agent was successful in addressing the client's concerns. If the client chooses to participate in the client survey, the call center 200 is capable of automatically transferring the client to the IVR system 400 for conducting the survey, for example, using the server 220 to perform the re-routing function. The IVR system 400 establishes a connection with the client's telephone 104 and then proceeds to automatically conduct the survey using interactive voice commands and touch tone responses, for example. Those skilled in the art will appreciate that the client also may be logged into the web site with computer 106 while the IVR system 400 conducts the survey via the telephone 104. The client may thus request online assistance while completing the survey. While the client is online with the web service, the client also may initiate a voice call to a call agent to request additional information. The client also may view an online help window that provides information about system requirements to further assist the client in placing a call to the call center 200. The BPM control module 312 tracks the feedback data and stores the data either in the host database 214 or the server database 119 and correlates the client and call agent with the feedback data.

The BPM software control module 314 also performs various functions such as, for example, associating the client's telephone number with the call agent's identification number, associating the client's personal information with the call agent's identification number, associating the results of the survey with the call agent's identification, associating the survey results with the client's personal information, and other association management functions that may be used to correlate the call agent with the client, the services rendered by the call agent, and how the client's needs were addressed. All of the management and statistical information may be stored in the database 214 or database 119 and may be accessed by the host computer 212 and the server 114 or the computers 115, 117 by any number of computers and other processing devices. The supervisor station 304 also may comprise a computer for monitoring current customer service processes in real-time, run and analyze reports, manually intervene with the process and resolve issues, and identify and resolve any bottlenecks in the process.

The BPM software module 314 manages the call center's 200 behavior and tracks the call center's 200 activities and behavior in real-time. The BPM software module 314 also initiates changes in current or future transactions for improving the overall efficiency and profitability of the call center 200. It includes an execution engine for monitoring, analyzing, and controlling the activities at the call center. For example, in one embodiment of the present invention, the control module 314 determines how calls should be distributed to the call agents within a queue based on the call agent's past performance with the client using the historical data stored in either database 119 or 214. The control module 314 monitors the call agent and queue performance in real-time and compares current performance against past performance stored in either database 119 or 214, for example. This enables continuous improvement of the call center's 200 performance.

The software modules 312, 314 in accordance with the various embodiments of the present invention described herein comprise executable code such as, for example, a software application (e.g., operating system, browser application, client application, server application, proxy application, on-line service provider application, and/or private network application) in communication with the ACD system 300, the agent workstation server 114, the computer 115, 117, and/or the host computer 212, for example, for directing the execution of instructions. Other examples may include an executable computer program, code, a set of instructions, or some combination thereof, for independently or collectively instructing the ACD system 300, the agent workstation server 114, computer 115, 177, and/or the host computer 212, for example, to interact and operate as programmed. The control modules 312, 314 may be implemented utilizing any suitable computer language (e.g., C\C++, UNIX SHELL SCRIPT, PERL, JAVA, JAVASCRIPT, HTML/DHTML/XML, FLASH, WINDOWS NT, UNIX/LINUX, APACHE, RDBMS including ORACLE, INFORMIX, and MySQL) and/or object-oriented programming techniques. The control modules 312, 314 also may comprise a device, such as a workstation or PC, a microprocessor, a microcontroller, a network server, a Java virtual machine, an application-specific integrated circuit, a programmable logic array, and/or a fixed logic array, and is not limited to software instructions alone.

The ACD system 300 also comprises, for example, a plurality of incoming voice communication lines 302, data lines 303, one or more call agent stations 110, one or more supervisor stations 304 or positions, and a switch for performing the actual call routing and distribution. Although any type of communication line 302 may be connected to the ACD system 300, various embodiments of the present invention may include communication lines such as, for example, toll-free 800 lines, plain old telephone service (POTS) lines, Integrated Services Digital Network (ISDN) lines, ISDN Primary Rate Interface (ISDN PRI) lines, and others, for example. The ACD system's 300 incoming voice communication lines 302 also may be routed through a PBX, for example in systems that use digital T1 trunks that carry both ACD related calls and other general call traffic. As discussed previously, the ACD system 300 also comprises a software control module 312 that automatically transfers a client call from the call agent to the IVR system 400 to conduct a client survey. The ACD system 300 thus can automatically re-route the client to the IVR system 400 at the end of the call agent/client transaction if the client elects to participate in the survey.

The features and functions of the ACD system 300 in accordance with the various embodiments of the present invention may be implemented using various types of equipment and services. For example, embodiments of the present invention may utilize a stand-alone ACD system that may be used in conjunction with client service centers remotely located from the rest of the organization and where the ACD system's functions do not need to be integrated with the organization's telephone system. For example, a client's call may be re-routed to an IVR system that is located remotely from the organization's telephone system. The ACD system 300 functionality also may be integrated as part of a PBX key telephone system comprising the ACD system 300 software control modules 314 in addition to the software control module 312.

Those skilled in the art will appreciate that the ACD system 300 may be a system component based on a personal computer or a workstation with additional software control modules or functions such as voice mail, interactive voice response (IVR), intelligent queue announcements, computer integration, and the software control modules 312, 314 discussed above. These additional software control modules also may be used to collect client call statistics and generate management reports associated with the client's usage and acceptance rate of participation in the survey.

Embodiments of the present invention also may utilize other types of ACD systems comprising independent devices that operate without a switching matrix of their own such as automatic call sequencers, for example. These types of ACD systems perform the same type of call-to-agent station allocation as the conventional switch based ACD system 300. The call sequencers based ACD systems may be simpler to operate and implement than the conventional ACD system 300 because they rely on the PBX for routing calls. Other embodiments of the present invention may be based on Centrex systems where the telephone company provides the ACD functionality and features as part of its Centrex service. Also, telephone company central office-based systems may be implemented where the telephone company provides ACD functionality and features as a service that is separate from Centrex. Further, third-party service firms may be contracted by the organization to provide its ACD services.

The operation of the ACD system 300 is geared towards maintaining a certain predetermined level of productivity of the call agents through the efficient distribution of incoming client calls. Managers such as, for example, a supervisor, or master, may be positioned at the supervisor station 304 portion of the ACD system 300. These managers have the ability to monitor individual client calls, call agents, and the overall ACD system 300 activity. The client survey results may be delivered directly to the managers in real-time. Accordingly, the managers may take immediate action based on the client survey results.

Various embodiments of the present invention also may utilize the ACD system 300 to answer incoming telephone calls either on the first ring or after a fixed number of rings, and then examine preprogrammed processing tables for routing instructions while the caller is placed on hold. The ACD system 300 also may answer calls dynamically by sensing incoming calls and searching through predetermined routing schemes before answering a call. Once the client call is answered, other systems such as the IVR system 400 may be used to gather additional information and compare that information with the information stored in the customer database 214 before transferring the call to the appropriate call agent station 110. The IVR system 400 also may present a query to the client regarding whether the client is willing to participate in a survey at the end of the transaction with the call agent. Although such structure can be provided within a variety of ACD systems, embodiments of the ACD system 300 according to the present invention include the software control module 312 for re-routing the client's call to the IVR system 400 at the end of the current transaction. Other embodiments of the ACD system 300 may include, for example, other methods of allocating client calls, different types of system management reports, and also may comprise various control functions.

Various embodiments of the present invention also may comprise a web-based ACD system 300 within the call center 200 environment operating over the network 218. In various embodiments of the present invention, the network 218 may be a corporate IP-based intranet or the Internet, for example. Web based ACD system 300 environments allows a client to click on a link provided within various web pages such that a voice connection may be established over the network 218 between the client and the call agent. The call is then transferred to the ACD system 300 where it is routed to the next-available call agent at one of the call agent stations 110. Web based ACD systems 300 also may re-route the client call to the IVR system 400 to conduct a client survey under the control of software control module 312.

Clients using such web based ACD systems 300 may reach the call agent using the personal computer 106 and clicking on a link portion of the web site. The ACD system 300 can be a Windows NT-based PNX ACD system, for example. An H.323 call setup occurs between the customer and the ACD system 300. When the call agent is available, an outbound call can be placed to the call agent to set up a conference between the client and the call. All of the H.323/T.120 packets pass through the ACD system 300. Once the call arrives, the call agent may use an interface that includes call-context information including, for example, the name of the client, account number, currently viewed URL, subscriber service level, the last time the client placed a call, and the results of the client survey if the client previously completed one. If the client previously completed a survey, the results of that survey may be associated with the previous call agent station 110 and/or the call agent's identification number. The client is then routed to the same call agent station 110 and/or call agent if the survey results were favorable. The client also may be routed away from that call agent station 110 and/or call agent if the results were unfavorable. In addition, the interface may include one or more virtual buttons or other interactive interface means to initiate queries to the client, such as, for example, asking the client whether they wish to participate in a survey. The interface also may include additional virtual buttons or other means for re-routing the client to the IVR system 400 to conduct the survey.

The IVR system 400 enables the client to conduct transactions with an organization without a live attendant. The IVR system 400 uses a telephone keypad as an information retrieval and data gathering medium. In general, a recorded voice message prompts the client with questions and a menu of choices for each question. The client then responds to the inquiries or commands by using the telephone touch tone keypad, for example. In various embodiments of the present invention, the IVR system 400 conducts the client survey by presenting one or more questions to the client from a predetermined list of questions stored in a computer by way of announcements. This type of communication exchange is sometimes referred to as audiotext.

In various embodiments of the present invention, the IVR system 400 accepts the call transferred by the ACD system 300 and administers a predetermined client survey by asking the client a number of questions in multiple-choice answer format. The client may respond to each question by entering the appropriate digit from the telephone 104 using its touch-tone keypad after the pre-recorded announcement. This type of IVR system 400 based client survey provides requested information to the organization immediately after the client completes a transaction with the call agent. Thus, the information provided in response to the survey is fresh, more likely to be accurate, and it is more likely that the client will actually engage in and participate in the survey. This enables the organization to meet its need for client feedback information efficiently and economically without having to devote additional staff to administer routine survey questions. Also, because the survey is administered over the IVR system 400 and responses are received electronically in real-time, the survey results can be easily and immediately tabulated and analyzed and stored in either database 119 or 212. Thus, a manager at the call center 200 supervisor station 304 can take immediate action and make routing adjustments within the call center 200 based on the real-time survey results. For example, if one of the call agent stations 110 consistently receives negative treatment on various client surveys, the manager can immediately re-route incoming calls from clients away from that particular call agent station 110 or call agent, for example. Conversely, if the survey results indicate that the particular client is pleased with the call agent, the manger can take immediate steps to route calls from that particular client to the preferred call agent and/or call agent station 110. What makes this possible is the ability of associating the particular call agent station 110 identification information (e.g., telephone extension number) and/or call agent identification number with the results of the client survey and storing this information in either database 119 or 214.

The BPM control module 314 provides a variety of monitoring, analytical capabilities, and metrics for tracking incoming calls to the call center 200 such that they are effectively distributed to the appropriate call agent and/or call agent station 110 based on the identity of the client. The BPM control module 314 then automatically and in real-time controls the ACD 300 such that the incoming calls are directed to the appropriate call agent and/or call agent station 110 based on a variety of factors determined by metrics stored in either database 119 or 214. The metrics are associated with the identity of the call agent, and/or the call agent station 110, and the client so that the information may be used later to determine where and how to route an incoming call. The metrics comprise, for example, the average length of time that a call agent spends with a specific client, the client's level of satisfaction with how a specific problem was resolved by a call agent, the client's overall satisfaction with a call agent, monitoring process activity to determine which processes a call agent is consuming the most amount of time, overall call agent utilization relative to a specific client, and allocation of an alternate suitable call agent, among other metrics, for example. Other metrics include measuring and tracking cost analysis based on specific clients and call agents and the distribution of costs among the call agents relative to a specific client.

The BPM control module 314 captures timing data and determines the length of time a call agent spends in resolving a client issue. The BPM control module 314 determines a call agent's responsiveness to a client by measuring the time duration between a transaction initiating event the final delivery to the client. The timing information is then stored in either database 119 or 212 and is associated with the client's identification information and the call agent's identification information and/or the call agent station 110 identification information to be used in subsequent transactions between the call agent and the client. The databases 119, 214 are updated continuously so that the client is matched with the call agent if the timing information is favorable (e.g., falls within certain predetermined acceptable limits set by the organization). If the timing information falls outside the predetermined acceptable limits, for example, the client will not be matched with that call agent and futures calls will be directed to other call agents until a match is determined. A history of client satisfaction to call agent timing performance is established and maintained over time so as to provide a continuous historic record.

The BPM control module 314 also measures and tracks a client's level of satisfaction with how a specific problem was resolved by a call agent and identifies whether the client was adequately served by the call agent. The client feedback data gathered at the end of a transaction is used to establish this metric. This problem resolution data also is stored in either database 119 or 212 and is associated with the client's identification information and the call agent's identification information and/or the call agent station 110 identification information to be used in subsequent transactions between the call agent and the client. A history of problem resolution with respect to client satisfaction is established and maintained over time so as to provide a continuous historic record.

The BPM control module 314 also measures and tracks a client's overall satisfaction with a particular call agent and uses the client feedback data to determine this metric. This data also is stored in either database 119 or 212 and is associated with the client's identification information the call agent's so that it can be retrieved and used whenever the client initiates a future transaction with the call center 200. A history of overall client satisfaction with a particular agent is established and maintained over time so as to provide a continuous historic record.

Other metrics also may be tracked using the BPM control module 314. These metrics include, for example, process activity monitoring to determine which call agent activities in dealing with specific clients consuming the most amount of the call agent's time. Other metrics include, for example, the measurement and tracking of overall call agent utilization relative to a specific client. If a call agent is overburdened by the client, for example, the BPM control module 314 reallocates or shifts the client to alternate suitable call agents in order to balance the each call agent's workload. The suitability of the alternate call agent is determined using any of the metrics described herein. This balancing function maintains an equilibrium of workload distribution among all suitable call agents while maintaining a predetermined level of quality of services rendered to the client.

The BPM control module 314 also may perform cost analysis based on specific clients and call agents. The cost of rendering quality services to a client are measured, tracked, and used in the overall decision making process in matching a client with a call agent. The BPM control module 314 also measures, identifies, and tracks the distribution of the cost of servicing specific clients among the call agents. Using this cost information enables the BPM control module 314 to redirect incoming calls to one or more call agents that are acceptable to the client based on an overall organization wide cost distribution model for servicing the client.

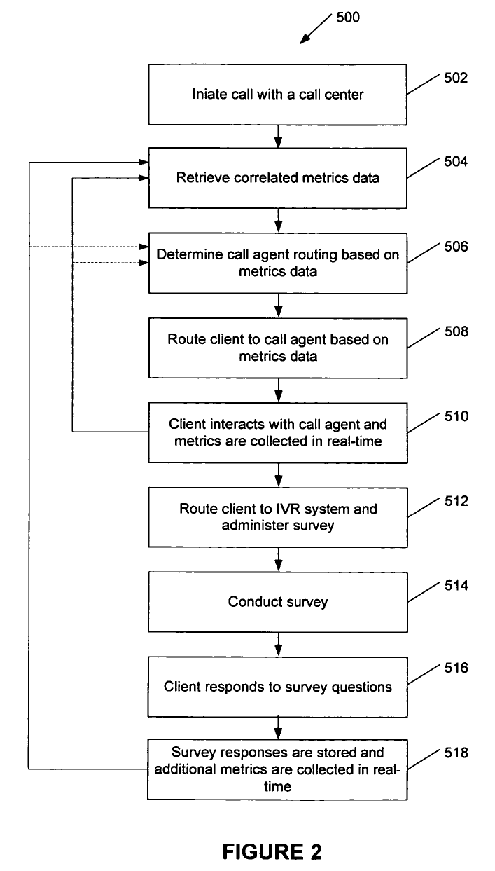

FIG. 2 is a process flow diagram 500 of various embodiments of the present invention. The process flow diagram 500 describes the steps that are executed in order to route an incoming call to the appropriate call agent. At block 502 the client initiates a transaction with the organization by placing a telephone call to the organization's call center 200 using the telephone 104. At block 506, the metrics data correlated between the client, call agent, and the client feedback data is retrieved from either database 119 or 214. At block 506, the BPM control module 314 determines which call agent to route the incoming call to based on the metrics data stored in either database 119 or 214. At block 508 the call center's 200 ACD system 300 routes the client to the appropriate call agent determined by the BPM control module 314. At block 510, after the call agent interacts with the client, the call agent notifies the client that they may choose to answer a survey, such as for example, a customer satisfaction survey. If the client agrees to participate in the survey, the call agent instructs the client to remain on the line. Furthermore, at block 510 metrics are collected in real-time by the BPM control modules 314. The metrics collected at block 510 are then stored in either database 119 or 214 and are fed back to block 504 so that they are readily available to be retrieved at block 504. In one embodiment of the present invention the metrics data collected at block 510 also may be fed back to block 506 such that the call agent routing may be based on the most current metrics data available. At block 512, the ACD system 300 under the control of software module 312, for example, re-routes the call to the IVR system 400, for example, to administer the survey. At block 514 the client listens to the directions for conducting the survey and listens to the questions posed by the IVR system 400. At block 516 the client responds to the questions asked in the survey using either the touch-tone keypad of the telephone 104 or a voice activated response mechanism. At block 518 additional metrics such as the client's responses, or data, are collected in real-time and are recorded, time stamped, and, optionally, tagged for client callback. The additional metrics collected at block 518 are then stored in either database 119 or 214 and are fed back to block 504 so that they are readily available to be retrieved at block 504. In one embodiment of the present invention the metrics data collected at block 518 also may be fed back to block 506 such that the call agent routing may be based on the most current metrics data available. At the end of the survey, the client may terminate the connection by hanging up the telephone.

Although the present invention has been described with regard to certain embodiments, those of ordinary skill in the art will recognize that many modifications and variations of the present invention may be implemented. The foregoing description and the following claims are intended to cover all such modifications and variations. Furthermore, the components and processes disclosed are illustrative, but are not exhaustive. Other components and processes also may be used to make systems and methods embodying the present invention.

1. A system, comprising:
an automatic call distribution system adapted to communicate over a network, wherein the automatic call distribution system comprises a software control module, and wherein the automatic call distribution system is configured to route incoming calls received from the network based on metrics information identified by the software control module; and
a call agent station in communication with the automatic call distribution system, wherein the call agent station is configured to receive incoming calls routed from the automatic call distribution system based on the metrics information determined by the software module.

2. The system of claim 1, further comprising an interactive voice response system in communication with the automatic call distribution system, wherein the interactive voice response system is configured to administer a survey to a client in communication with the call agent station, and wherein, under the control of the software control module, the automatic call distribution system routes the incoming call from the call agent station to the interactive voice response system for administering the survey to the client.

3. The system of claim 1, wherein the incoming call is routed to the call agent station occupied by a call agent based on a metric, wherein the metric is correlated between the call agent and a client initiating the incoming call.

4. The system of claim 3, wherein the metric is a timing metric.

5. The system of claim 3, wherein the metric is a specific client level of satisfaction metric.

6. The system of claim 3, wherein the metric is an overall client level of satisfaction metric.

7. The system of claim 3, wherein the metric is a process activity metric.

8. The system of claim 3, wherein the metric is an overall call agent utilization metric.

9. The system of claim 3, wherein the metric is a cost analysis metric.

10. A system, comprising:
an automatic call distribution system adapted to communicate over a first network and a second network, wherein the automatic call distribution system comprises a software control module, and wherein the automatic call distribution system is configured to route incoming messages received from the first network and is configured to route incoming calls received from the second network, wherein the messages and the calls are routed based on metrics information identified by the software control module;
a server in communication with the automatic call distribution system, wherein the server is adapted for receiving the incoming messages from the first network; and
a call agent station in communication with the automatic call distribution system, wherein the call agent station is configured to receive the incoming messages and incoming calls routed from the automatic call distribution system based on the metrics information determined by the software control module.

11. The system of claim 10, further comprising an interactive voice response system in communication with the automatic call distribution system, wherein the interactive voice response system is configured to administer a survey to a client in communication with the call agent station through the first and second networks, and wherein under the control of the software control module, the automatic call distribution system routes the incoming call from the second network to the interactive voice response system for administering the survey to the client.

12. The system of claim 10, wherein the first network is the Internet.

13. The system of claim 10, wherein the second network is a telephone network.

14. The system of claim 10, wherein the call agent station further comprises an Internet Protocol telephone.

15. The system of claim 10, wherein the incoming call is routed to the call agent station occupied by a call agent based on a metric, wherein the metric is correlated between the call agent and a client initiating the incoming call.

16. The system of claim 16, wherein the metric is a timing metric.

17. The system of claim 16, wherein the metric is a specific client level of satisfaction metric.

18. The system of claim 16, wherein the metric is an overall client level of satisfaction metric.

19. The system of claim 16, wherein the metric is a process activity metric.

20. The system of claim 16, wherein the metric is an overall call agent utilization metric.

21. The system of claim 16, wherein the metric is a cost analysis metric.

22. A method of conducting a survey with a client, comprising:
initiating an incoming call with a call center by a client; and
at the call center, routing the incoming call to a call agent based on metrics information correlated between the client and the call agent.

23. The method of claim 22, further comprising conducting a survey with the client through the interactive voice response system, wherein the interactive voice response system presents survey questions to the client.

24. The method of claim 22, further comprising routing the incoming call to a call agent based on a timing metric data.

25. The method of claim 22, further comprising routing the incoming call to a call agent based on a specific client level of satisfaction metric.

26. The method of claim 22, further comprising routing the incoming call to a call agent based on an overall client level of satisfaction metric.

27. The method of claim 22, further comprising routing the incoming call to a call agent based on a process activity metric.

28. The method of claim 22, further comprising routing the incoming call to a call agent based on an overall call agent utilization metric.

29. The method of claim 22, further comprising routing the incoming call to a call agent based on a cost analysis metric.
